(19) United States
(12) Patent Application Publication
(10) Pub. No.: US 2020/0175598 A1
(43) Pub. Date: Jun. 4, 2020

(54) SYSTEM AND METHODS FOR AGGREGATING INVESTMENT, EDUCATIONAL AND ENTERTAINMENT DATA AND DISPLAY OF THE DATA THEREOF

(71) Applicants: Linwood MA, Chicago, IL (US); Kristi ROSS, Oak Park, IL (US); Tom SOSNOFF, Chicago, IL (US)

(72) Inventors: Linwood MA, Chicago, IL (US); Kristi ROSS, Oak Park, IL (US); Tom SOSNOFF, Chicago, IL (US)

(73) Assignee: Dough, Inc., Chicago, IL (US)

(21) Appl. No.: 16/209,257

(22) Filed: Dec. 4, 2018

Related U.S. Application Data
(63) Continuation of application No. 14/500,449, filed on Sep. 29, 2014, now abandoned.
(60) Provisional application No. 61/883,676, filed on Sep. 27, 2013.

(51) Int. Cl. G06Q 40/06; G06Q 10/04; G06Q 30/02; G06Q 40/04

(52) U.S. Cl. CPC G06Q 40/06; G06Q 40/04; G06Q 30/0206; G06Q 10/04

(57) ABSTRACT

A system and method that aggregates investment, educational and entertainment data for consumers in a visually simplified way. In an embodiment, a system for such aggregated data can include a database containing investment data and investment education data and a processor in communication with the investment database and investment education database. In an exemplary embodiment, the processor may be included in a web server. The processor may be configured to execute instructions to provide a graphical user interface (GUI) to display visuals and accept queries from users according to at least one of the investment data and the investment education data. The GUI can include an educational portion and an investment portion. The processor can be configured to display through the GUI appropriate educational content from the educational portion and appropriate investment content from the investment portion.

### CROSS-REFERENCE TO RELATED APPLICATION

This application claims the benefit of U.S. provisional application No. 61/883,676, filed Sep. 27, 2014, which is hereby incorporated by reference in its entirety.

### FIELD OF THE INVENTION

The present disclosure relates generally to a system and methods for analyzing investment data. More particularly, the disclosure relates to a system and methods for visual reductive display of stock and options information, incorporation of relevant statistical models and seamless integration of educational and content feeds across web browsers, tablets and mobile devices.

### BACKGROUND OF THE INVENTION

The development of online stock brokerage has led to the proliferation of computer-based brokerage and investment applications. The focus of these applications have typically been to provide sophisticated consumers with more and more complex tools to analyze investment opportunities. These tools may include complex charting, order routing and product discovery. The end result is that the average consumer is left more overwhelmed than actually helped by the current investment applications.

Thus, there is a need for a system and method for aggregating investment, educational and entertainment data and display of the data thereof. The present disclosure solves these and other disadvantage of the prior art.

### SUMMARY OF THE INVENTION

A system and method that improves on the prior art can aggregate investment, educational and entertainment data for consumers in a visually simplified way. Such a system and method can also allow consumers to make stock and option trades based upon the aggregated data, increasing consumer confidence in their trading. There are a number of ways to do this including: a) a spatial system for managing trade entry and exit utilizing helpful statistics like probability of profit, return on capital, and un-captured profit, that also helps with easier uptake of educational concepts through a simple to understand graphical representation of trades b) graphing of account profit and loss zones against major indexes to understand favorable and unfavorable market conditions, c) mapping of ideal trade entry and exit positions based on implied volatility, remaining profit, and historical trends, d) learning to trade or invest through watching others trade, instead of more traditional learn then apply education, simplified by a visual trading interface, e) the use of graphical interpretation of individual's trading historical performance to provide 20-20 hindsight learning for individuals to improve their future investing performance and f) the capture of conditions at trade entry to provide user the ability to review profitable and unprofitable investing behavior, as well as to let the system learn to identify trades that may be relevant for a given user.

A system that provides the above-noted advantages can include a database containing investment data and investment education data and a processor in communication with the investment database and investment education database. In an exemplary embodiment, the processor may be included in a web server. The processor may be configured to execute instructions to provide a graphical user interface (GUI) to display visuals and accept queries from users according to at least one of the investment data and the investment education data. The GUI can include an educational portion and an investment portion. The processor can be configured to display through the GUI appropriate educational content from the educational portion and appropriate investment content from the investment portion. The processor may also be configured to display appropriate investment content during the educational portion and display appropriate educational content during the investment portion. Such a system would allow for seamless integration from the educational portion to the investment portion and from the investment portion to the educational portion, thereby enhancing the investment learning experience of a consumer.

### BRIEF DESCRIPTION OF THE DRAWINGS

FIG. 1 is a block diagram view of an exemplary embodiment of a system for digital investment, education and entertainment.

FIG. 2 depicts an embodiment of a welcome page for an exemplary embodiment of a graphical user interface (GUI) for an investment, educational and entertainment application.

FIG. 3 depicts an embodiment of an educational page for an exemplary embodiment of a GUI for an investment, educational and entertainment application.

FIG. 4 is an example of a courses and activities feature of an education page for an investment, educational and entertainment application.

FIG. 5 depicts an embodiment of a login and top level navigation page for an exemplary embodiment of a GUI for an investment, educational and entertainment application.

FIG. 6 depicts an embodiment of a trading home page for an exemplary embodiment of a GUI for an investment, educational and entertainment application.

FIG. 7 depicts an embodiment of an example trades details page for an exemplary embodiment of a GUI for an investment, educational and entertainment application.

FIG. 8 depicts an embodiment of a trade tracking page for an exemplary embodiment of a GUI for an investment, educational and entertainment application.

FIG. 9 depicts an embodiment of a user portfolio page for an exemplary embodiment of a GUI for an investment, educational and entertainment application.

FIG. 10 depicts an example of an interactive feature of a user portfolio page for an exemplary embodiment of a GUI, showing further information about an individual position listed in the portfolio page.

FIG. 11 depicts an embodiment of a page for watching and analyzing relevant stock positions for an exemplary embodiment of a GUI for an investment, educational and entertainment application.

FIG. 12 depicts an example of the position details feature that can be accessed from a page for watching and analyzing relevant stock positions for an investment, educational and entertainment application.

FIG. 13 depicts an embodiment of an account history page for an exemplary embodiment of a GUI for an investment, educational and entertainment application.

FIG. 14 depicts an example of a feature allowing a user to change and interact with existing orders.

FIG. 15 depicts an embodiment of a journal page for an exemplary embodiment of a GUI for an investment, educational and entertainment application.

FIG. 16 depicts an embodiment of an order entry page for an exemplary embodiment of a GUI for an investment, educational and entertainment application.

FIG. 17 depicts an example of an order entry tools menu for an order entry page for an exemplary embodiment of a GUI for an investment, educational and entertainment application.

FIG. 18 depicts an example of a details feature of an order entry tools menu for an order entry page.

FIG. 19 depicts an example of a default order selection feature of an order entry page for an exemplary embodiment of a GUI for an investment, educational and entertainment application.

FIG. 20 depicts an exemplary embodiment of profit and loss zones on a probability distribution of a stock price.

FIG. 21 depicts an exemplary embodiment of a quick mutation interface.

FIG. 22 depicts an exemplary embodiment of the operation of a “lower strike” quick mutation through the interface of FIG. 21.

FIG. 23 depicts an exemplary embodiment of the operation of a “wider strike” quick mutation through the interface of FIG. 21.

FIG. 24 depicts an exemplary embodiment of the operation of a “further time” quick mutation through the interface of FIG. 21.

FIG. 25 depicts an exemplary embodiment of the operation of a “swap direction” quick mutation through the interface of FIG. 21.

FIG. 26 depicts as exemplary overlay of a stock price probability distribution, profitability zones, and parameters of an order.

FIG. 27 depicts an exemplary embodiment of a spatial strike price menu.

### DETAILED DESCRIPTION

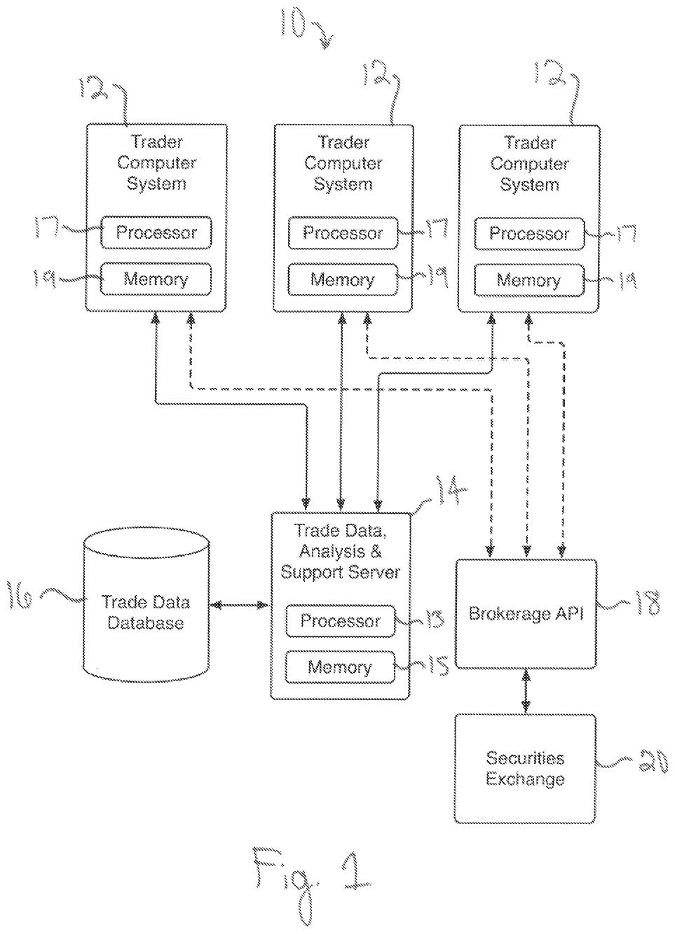

Referring to the drawings, wherein like reference numerals refer to the same or similar features in the various views, FIG. 1 is a block diagram view of an exemplary system 10 for trading securities. The system 10 may include a plurality of trader computer systems 12 (three such trader computer systems are illustrated in FIG. 1), a trade data, analysis, and support server 14 (which may be referred to herein as a trading platform server 14), a trade data database 16, a brokerage application programming interface (“API”) 18, and a securities exchange 20.

The securities exchange 20 may be a marketplace for buying and selling securities (not shown) such as, for example only, stocks, bonds, futures, and options. The exchange 20 may be or may include an electronic marketplace, a live marketplace, or any other type of marketplace for buying and selling securities (not shown). The present disclosure will be described with reference to embodiments in which the traders purchase and sell, and the brokerage 18 facilitates the purchase and sale of, stock options. It should be understood, however, that the present disclosure is not limited to stock options. Rather, the system and methods illustrated and described herein may find use with any type of securities.

The brokerage API 18 may be accessed by users of the trader computer systems to facilitate buying and selling of stock options by traders on the exchange 20. Accordingly, the traders may access the brokerage API 18 directly (i.e., through the trader computer systems 12) and/or indirectly (e.g., through the trading platform server 14), in embodiments. In an embodiment, the brokerage API 18 may facilitate the receipt of orders for buying and selling stock options electronically from the traders and cause the ordered trades to be made on the exchange 20 (e.g., by a trader at the brokerage associated with the brokerage API 18, for example).

Each of the trader computer systems 12 may be configured to provide access to a trading platform which may be or may include an investment, educational and entertainment application. The trading platform may be operated by a trader to, for example, order option trades on the exchange, view stock and options prices and other trading data, access educational and entertainment materials, and view data respective of one or more accounts held by the user with the brokerage associated with the brokerage API 18. The trading platform (which may be referred to herein simply as “the platform”) may include and provide a graphical user interface (GUI) having a number of features described above and below. Portions, or all, of the GUI may be provided by the trading platform server 14, in an embodiment. Accordingly, in an embodiment, the trading platform server 14 may be configured to perform one or more operations, methods, etc. described herein that enable various trading functionality for a trader.

The trading platform server 14 may be configured to perform a number of functions to assist traders in their trading decisions. For example, the trading platform server 14 may be configured to provide stock and options prices, educational and entertainment information, and other information to traders through the trader computer systems 12. Stock and options prices may be obtained by the trading platform server 14, in an embodiment, from the brokerage associated with the brokerage API 18 and/or from the securities exchange 20.

The trading platform server 14 may be further configured to store data in and retrieve data from the trade data database 16. Data stored in the trade data database 16 may include records of trades ordered by traders, records of trades executed by or through the brokerage, historical stock and options prices, and similar information related to trading services that may be performed through the trading platform 10.

The database 16 may be or may include one or more data repositories including, but not limited to, one or more databases and database types as well as data storage that may not necessarily be colloquially referred to as a “database.” The database 16 may be configured to store, e.g., records of trades ordered by traders, records of trades executed by or through the brokerage 18, historical stock and options prices, investment education and entertainment information, and similar information related to trading services that may be performed through the trading platform.

The trading platform server 14 may be in electronic communication with the trader computer systems 12 and with the brokerage to obtain and deliver stock and options prices, trader orders, and other information, in an embodiment. In embodiments, the trading platform server 14 may be owned or operated by the brokerage. Furthermore, the trade platform server 14 may be a single server, or multiple servers acting in a redundant or additive capacity.

In embodiments, the trader computer systems 12 may be configured to perform one or more of the functions described herein with reference to the trading platform server 14 and/or the brokerage. Accordingly, the trader computer systems 12 may be in direct electronic communication with the brokerage, the trade data database 16, and/or the securities exchange 20.

The trading platform server 14 may include a processor 13 and a memory 15. The processor 13 may be any appropriate processing device. The memory 15 may be any volatile or non-volatile computer-readable memory. The memory 15 may be configured to store instructions that embody one or more steps, methods, processes, and functions of the trading platform server 14 described herein. The processor 13 may be configured to execute those instructions to perform one or more of the same steps, methods, processes, and functions.

Each of the trader computer systems 12 may also include a processor 17 and a memory 19, with three processors and three memories illustrated in FIG. 1. Each processor 17 may be any appropriate processing device. Each memory 19 may be any volatile or non-volatile computer-readable memory and may be configured to store instructions that embody one or more steps, methods, processes, and functions of the trader or trader computer system 12 described herein. The processor 17 may be configured to execute those instructions to perform one or more of the same steps, methods, processes, and functions. One or more of the trader computer systems 12 may be or may include a personal computer or mobile device (e.g., tablet, smartphone), in an embodiment.

Instead of, or in addition to, a processor 13, 17 and memory 15, 19, the trading platform server 14 and/or one or more of the trader computer systems 12 may include a programmable logic device (PLD), application-specific integrated circuit (ASIC), or other suitable processing device (not shown).

As noted above, a trader in the system 10 may be provided with a platform for, among other things, ordering the purchase and sale of stock options, reviewing trading data, and accessing educational and entertainment information. The platform may be provided, in an embodiment, by both the trader computer system 12 and the trading platform server 14. That is, some elements or features of the platform may be installed on the trader computer system 12, and other elements or features of the platform may be provided by the trading platform server 14 (e.g., on a software-as-a-service (SaaS) basis). For example, the trader computer system 12 may provide (i.e., may have installed) a program that includes a graphical user interface of the platform, and the trading platform server 14 may provide much of the underlying data and calculations. However, storage and retrieval of data displayed in the platform, calculations performed by or under the platform, and services provided through the platform may be performed by one or both of the trader computer system 12 and the trading platform server 14.

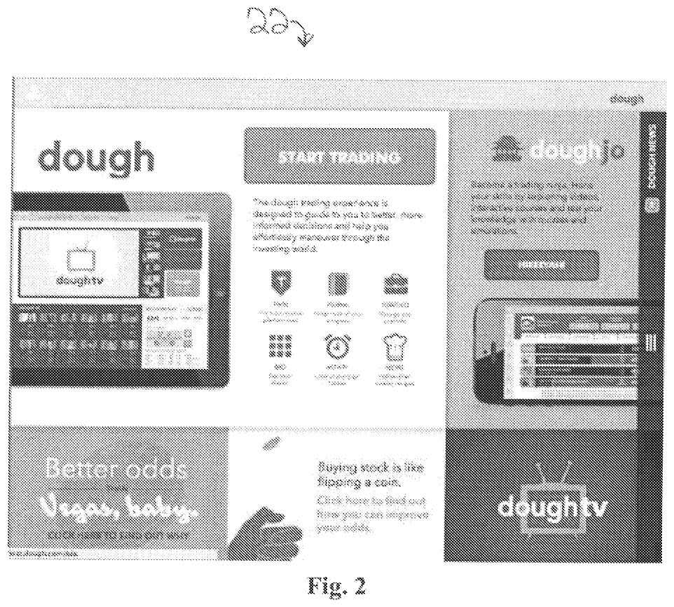

FIG. 2 is an embodiment of a welcome page 22 for an investment, educational and entertainment application. The welcome page may serve as a central hub for users of the trading platform. The welcome page 22 may feature and highlight new content, activities and areas of engagement. From the welcome page may be able to navigate to other areas of the platform. For example, users may access an investment portion, an educational portion and an entertainment portion through the welcome page 22, in an embodiment.

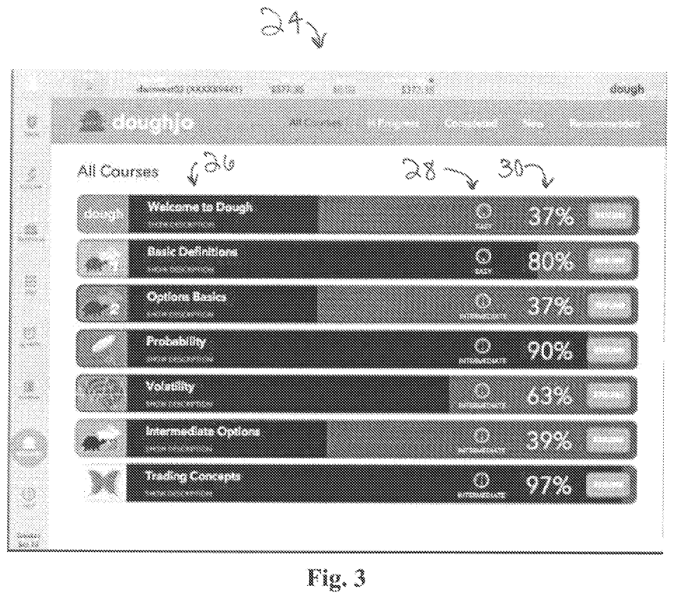

FIG. 3 depicts an exemplary educational page 24 for an education portion of the application. The educational page may provide access to courses, lessons, quizzes, simulations and other learning exercises. Referring to FIGS. 1 and 3, the educational content available through the educational page 24 may be derived from investment education data from the database 16. A plurality of educational topics 26 may be provided through the educational page 24. For each topic 26, in an embodiment, a learning difficulty 28 may be indicated, as may a percentage of completion 30 of the materials for that topic. In addition, the page may display various achievement awards to the user as the user completes various learning exercises.

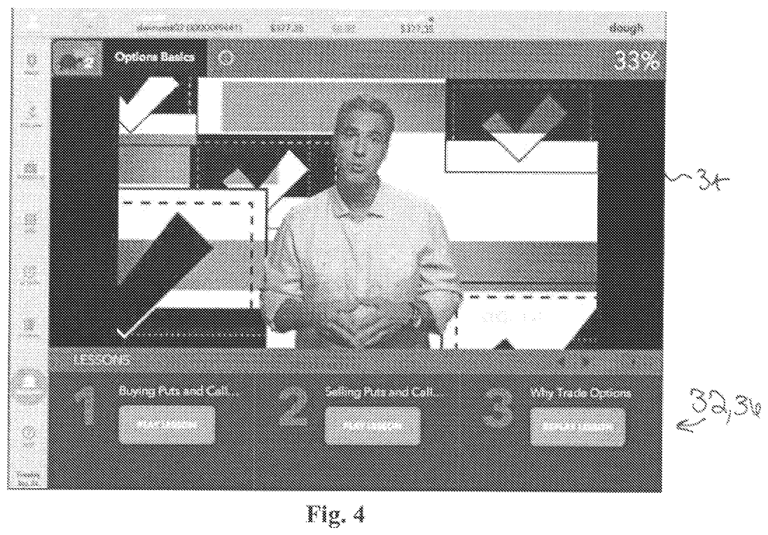

FIG. 4 depicts an exemplary set 32 of courses and activities that may be available through the educational page 24 (see FIG. 3). In the educational portion, a user can learn about investing in a simplified and entertaining way through a plurality of educational tools, including a main educational video, supplemental videos, quizzes, simulations and exercises. The educational tools can be sorted by various investment topics. Error! Reference source not found., for example, depicts a main video 34 and buttons 36 to access other educational tools covering buying puts and calls basics.

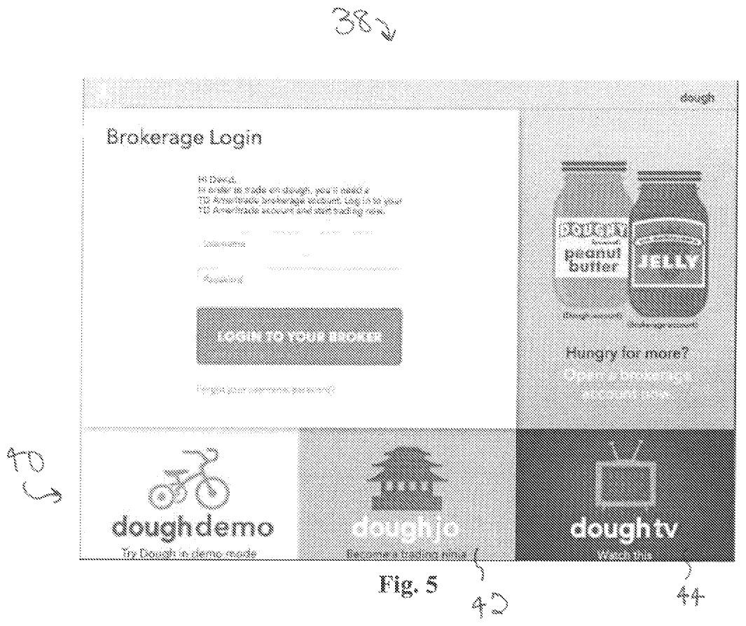

FIG. 5 depicts an embodiment of log-in and top level navigation page 38 for an investment, educational and entertainment application. The log-in and top level navigation page 38 may include a menu navigation bar 40 that can contain top-level navigational features to various portions of the application. For example, it may contain navigational features 42, 44 to one or more of a welcome page or portion, an educational page or portion, an entertainment portion or page, and an investment portion or page.

A user may have or be associated with one or more accounts to access certain features of the application. In one embodiment, a user can have a single login for the entire application or platform. In another embodiment, a user can have a login or account for the educational and entertainment portions and another account or login for the investment portions. For example, referring to FIG. 1, one login may permit communication between a trader computer system 12 and the platform server 14, and a second login may permit communication between the trader computer system 12 and the brokerage API 18. This two account embodiment would allow for increased security measures to protect a user's confidential information related to a user's investment account, in an embodiment. The second account may be a user's own brokerage account, in an embodiment.

Finally, the application may not require an account for some portions while requiring it for others. For example, a user may only need an account for the investment portion and not for the educational and entertainment portions.

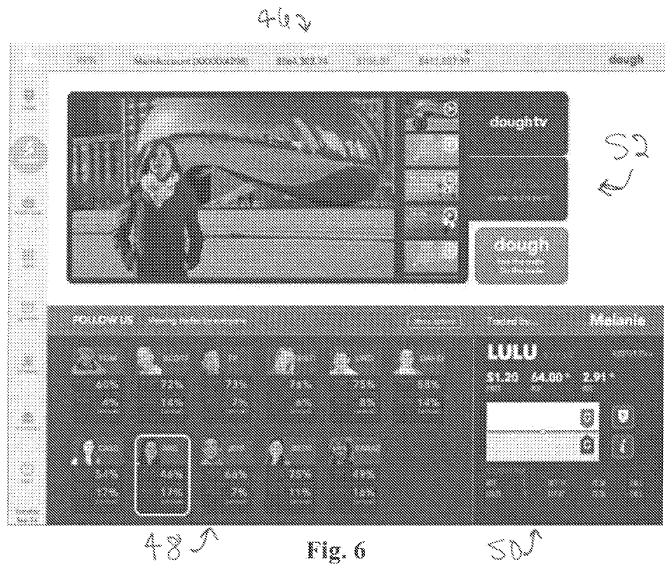

In an embodiment with a brokerage account, after a user logs-in, the application may display a trading home page through the graphical user interface. FIG. 6 depicts an embodiment of a trading home page 46 for an investment, educational and entertainment application.

In one embodiment, the trading home page 46 may contain visuals and queries designed to engage the user with trading ideas, trading patterns and exemplary real trades. For example, the page may contain information 48 on real traders. Such real trader information 48 may include individual trading profiles on the real traders, including the real traders' preferences and experiences. It may also display statistics about the real traders' trades. Such statistics can include the trader's current probability of profit and return on capital. It should be appreciated that the real traders can be users of the application, professional traders or fictitious traders processed from investment data and investment education data.

From the trading home page 46, a user can learn more about a real trader and his or her trades through features such as an activity feed and a trade recipe feature. Each real trader may be associated with one or more trade recipes. A trade recipe may be data associated with the underlying patterns, goals and mechanics of a real trader's trades. The real trader information can then be even further processed into data associated with each individual trade. This data can be displayed in an interface portion 50 and may include trade structure, probability of profit, return on capital, time of trade, underlying quote and visual structures and related diagrams, in an embodiment.

In addition to seeing information on the trading behaviors of selected individuals, a portion 52 of the trading home page 46 may use live or pre-recorded video playlists to present real-time programming. Instead of more traditional investor education, the platform can utilize a “learn by watching others do” style of teaching, where viewers are able to follow and see others trading live and on air while discussing the trades that they are making, in order to learn and understand how to invest for themselves. This style of educational programming utilizes the software as a teaching tool, and helps users to more easily grasp concepts that are being taught as they see others use the tool and explain how they are investing. Also, the use of visuals in the trade interface and pictorial representation of trades simplifies the investing learning process for new users.

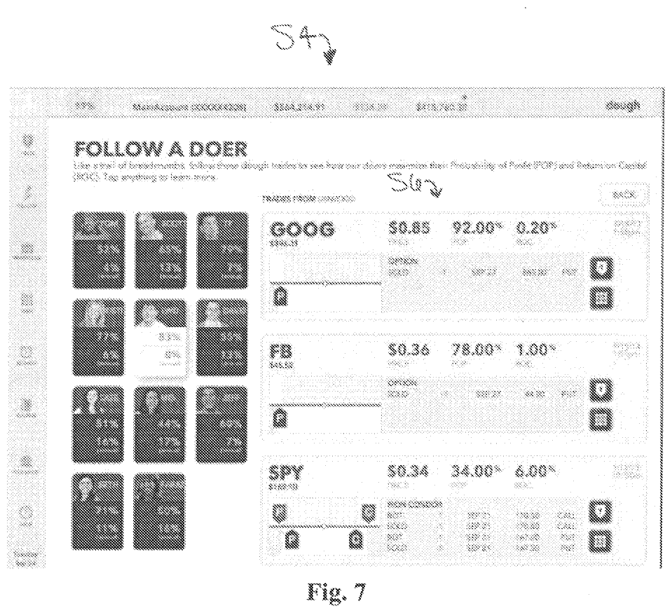

FIG. 7 depicts an embodiment of an example trades details page 54 illustrating “trade recipes” 56 respective of several trades made by a real trader. The trade recipe details 56 allow the user to clearly identify the pattern of trading that makes up the recipe. The trade recipe details 56 may include a detailed diagram, description and structure, an underlying symbol, the probability of profit and return on capital, in an embodiment. It may also include any commentary or notes, allowing for further explanation and insight into the real trader's trades. For example, the notes or comments may explain in more detail the context and background of the trade. The recipes 56 may allow for exemplary visual display of actual or fictitious trades, enhancing the educational portion through demonstrating how the trades interact with an entire portfolio in a real world setting.

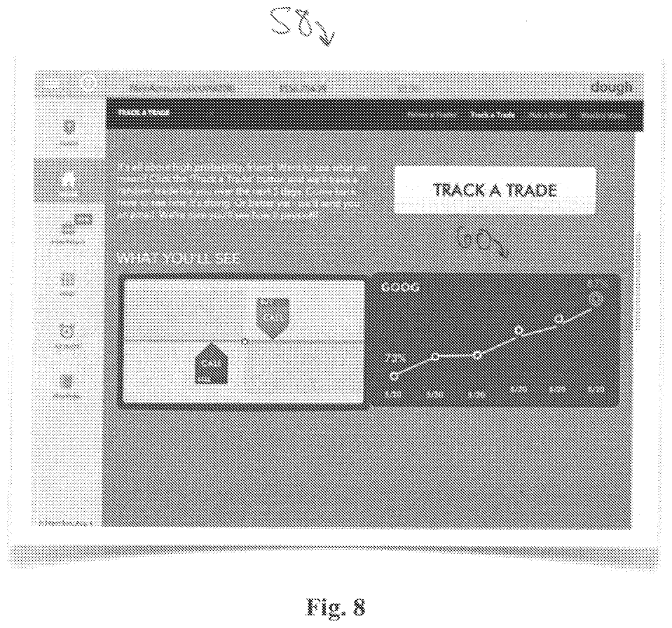

FIG. 8 depicts an embodiment of a trade tracking page 58. The trade tracking page 58 may include, in an embodiment, a display of relevant data 60 about a selected trade over a set or selected time frame. Such data can include the trade's current status, periodic snapshots of the progress of the trade, changes in the probability of profit and return on capital and the market value of the trade. The application may provide tracking for all possible trades or may be limited to only show exemplary educational trades or trades representing a high probability of profit.

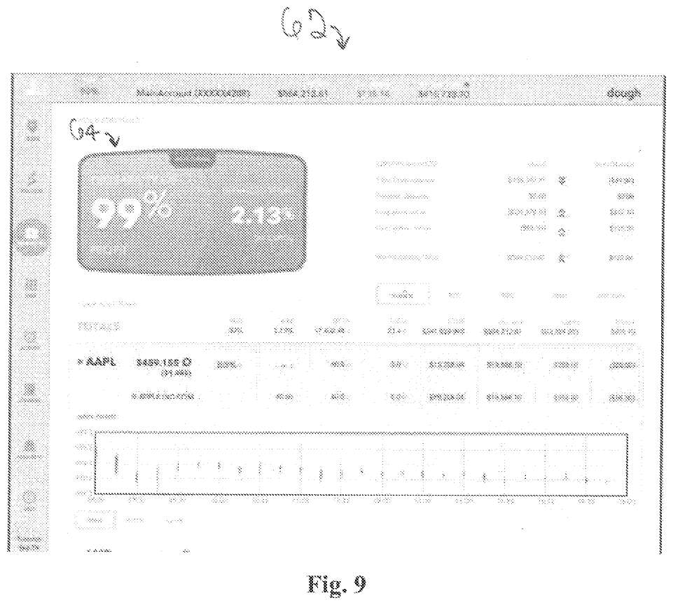

FIG. 9 depicts an embodiment of a user's portfolio page 62 for an investment, educational and entertainment application. In one embodiment, the user can access his or her individual open and closed stock and option positions through the portfolio page 62. The portfolio page 62 may highlight certain statistics related to the stock and options such as probability of profit 64, return on capital, delta and theta positions, total gain, current last price of the stock and the net change for the day. These statistics can be derived from the trade data database and processed by the platform server (see FIG. 1) into meaningful and explanative visuals and can be provided to the users through the platform GUI.

As described above, one metric or statistic that may be provided to a user is a probability of profit of one or more positions (i.e., up to the entirety of the user's portfolio). The probability of profit may be displayed along with and compared to movements in particular stock indices to illustrate for the user which movements in which indices are likely to cause positive and negative movement in the user's probability of profit with respect to one or more positions. Eventually, users can be shown a visual guide of their positions against a common index, that would allow users to gain a visual understanding of how the positions they have undertaken, long, neutral, or short, and what kind of overall stock market moves would create situations that would be profitable for the user.

Probability of Profit Calculation. A probability of profit (“PoP”) for an order with an underlying stock may be calculated according to a method that generally comprises: (a) determining profit and loss zones along a continuum of possible prices for the stock; (b) integrating the price probability distribution function for each profit and loss zone to determine the area “under the curve” for profitable zones and loss zones; and (c) calculating the ratio of “area” for profit zones to those of loss zones. This ratio may be considered the probability of profit, in an embodiment. Steps (a), (b), and (c) are described in further detail below.

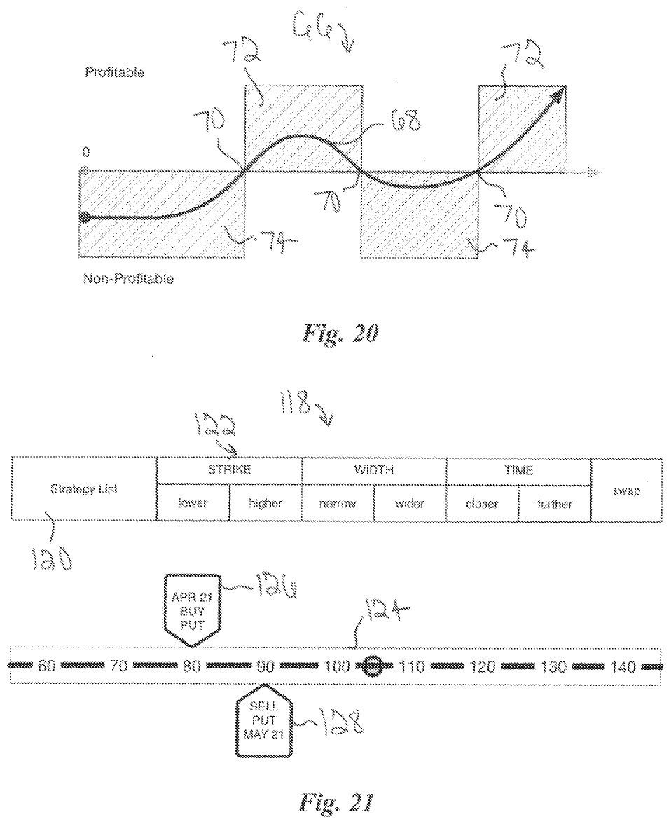

Probability of Profit Calculation—Determine Profit and Loss Zones. To determine profit and loss zones, the following method may be followed, in an embodiment: (i) calculate break-even points (also known as zero points, or roots), which are boundaries of the profit and loss zones; and (ii) use a price within each zone to evaluate the P/L of each leg or position of the order as to that zone, sum the respective P/L of each leg or position within each respective zone, and use the resulting respective summed P/L of each zone to determine, separately for each zone, if that zone is profitable, non-profitable, or neutral. FIG. 20 depicts a plot 66 illustrating an exemplary P/L function 68 to which steps (i) and (ii) above may be applied. As shown in FIG. 20, the exemplary P/L function 68 has three roots 70, two profitable zones 72, and two non-profitable zones 74.

Calculating a Probability Distribution Function. A probability distribution function, as discussed herein with reference to a single order, may be a probability distribution of a stock's future price. The distribution may be a log-normal distribution, in an embodiment. The distribution may generally be centered on the price of the stock as of the time of calculation of the distribution (i.e., such that the “current” price is the mean value in the distribution function), with a standard deviation determined according to the implied volatility of the stock. Implied volatility may be determined, in turn, according to current option prices (since there is a known correlation between the implied volatility of a stock and different option prices associated with that stock) and a model such as, for example only, the Black-Scholes method, which is described and further utilized in the steps below.

Calculating Break-Even Points. In some embodiments, the structure of an order may result in a known number of profit zones for that order. To calculate a probability of profit in such embodiments, a closed form calculation methodology may be applied to determine the break-even points of the order (also referred to as zero points, or roots), thereby determining the boundaries of the profit zones.

Some order types may have two profit zones. Exemplary order types with two profit zones may include single option leg orders, vertical spreads, and stock orders.

In an exemplary embodiment, the probability of profit for a single option leg order may be calculated first by determining the break-even point on the trade, as noted above. This may be calculated, for example, by taking the strike price of the option and adding or subtracting the price of the trade (depending on whether the option contract is a put or call). For example, for a short put, the price of the trade is subtracted from the strike price to find the break-even point. For a call, the price of the trade is added to the strike price to find the break-even point.

For single option leg orders, a “premium” zone may also be defined (in addition to a profitability zone). The premium zone may be defined as the range of prices where the option is in the money but not yet at the break-even point. The premium zone may be bounded by the strike price of the option on one end and the break-even point of the trade on the other end. The premium zone can exist as part of the positive or negative zone, depending on whether the option contract is a buy or sell.

In another exemplary embodiment, for a vertical put spread, the break-even point may be calculated by subtracting the trade price from the higher of the two respective strike prices of the two respective legs of the spread. For a vertical call spread, the break-even point may be calculated by adding the trade price to the lower of the two respective strike prices of the two respective legs of the spread.

In another embodiment, for a covered stock order, the break-even point may be calculated by adding the credit to or subtracting the debit of the option leg from the price of the stock leg (debit for buy, credit for sell).

In another embodiment, the break-even point for a stock order may be the price of the trade. After the break-even point is found, it may be applied to the distribution curve to determine the likelihood that the stock will be in the positive value zone(s) of the order at expiration.

In other exemplary order types and trade strategies, three profitability zones may exist. Such strategies may include strangle, iron condor, butterfly, jade lizard, and calendar spreads, which are option trading strategies known in the art.

In an embodiment, for a strangle strategy, the first break-even point may be calculated by subtracting the price of the order from the strike price of the put contract. The second break-even point may be calculated by adding the price of the trade to the strike price of the call contract. After the break-even points are found, they may be applied to the distribution curve to determine the likelihood that the stock will be in the positive value zone(s) of the order at expiration.

In an embodiment, for an iron condor strategy, the first break-even may be calculated by subtracting the price of the order from the strike price of the higher put contract. The second break-even point may be calculated by adding the price of the trade to the strike price of the lower call contract. After the break-even points are found, they may be applied to the distribution curve to determine the likelihood that the stock will be in the positive zone(s) of the order at expiration.

In an embodiment, for a butterfly strategy, the first break-even point may be calculated by adding the price of the order to the strike price of the lowest option contract. The second break-even point may be calculated by subtracting the price of the trade from the strike price of the highest option contract. After the break-even points are found, they may be applied to the distribution curve to determine the likelihood that the stock will be in the positive zone(s) of the order at expiration.

In a further embodiment, for an iron condor strategy that is skewed (that is, where the put vertical strike width is not equal to the call vertical strike width), an open form calculation may be used in place of the closed form calculation. Similarly, in an embodiment, for a butterfly strategy that is skewed (that is, where the lower strike width is not equal to the higher strike width), an open form calculation may be used.

In embodiments, different jade lizard strategies can have either one or two break even points. First, jade lizard trades with no upside risk may have one break-even point. That break-even point may be calculated by taking the price of the trade and subtracting the cost of the trade from the strike price of the short put. For a reverse jade lizard trade with no downside risk, the one break-even point may be found by adding the price of the trade to the strike price of the short call.

For a jade lizard trade with upside risk, a second break-even point may exist and may be calculated by adding the price of the trade to the lower call strike price. For a reverse jade lizard with downside risk, a second break-even point may be found by subtracting the price of the trade from the higher put strike price. After the one or two break-even points are found, they may be applied to the distribution curve to determine the likelihood that the stock will be in the positive value zone(s) of the order at expiration.

In an embodiment, a probability of profit for a calendar spread trade may be calculated first by estimating the break-even points for the earliest expiration. The break-even points may be estimated by using the Black-Scholes equation to determine the estimated value of both options at the earliest expiration, in an embodiment. To find the break even points, a root finding algorithm may be applied, in an embodiment. After the break-even points are found, they may be applied to the distribution curve to determine the likelihood that the stock will be in the positive value zone(s) of the order at the earliest expiration.

In embodiments where a closed form equation is not feasible or does not exist, an open form equation may be applied to determine break-even points. In an exemplary embodiment, an open form algorithm may use a formula that defines profit and loss (P/L) for each element of the order at a given underlying stock price and steps through a range of underlying stock's prices to find where the order's P/L crosses or touches the zero value, also referred to as the root. Such formulas are described in greater detail below. With the roots found, the profitable areas between the roots may be defined along the underlying security's price range and thus may be used to subdivide the price probability distribution into areas of loss and profit. The ratio of profit to loss may be considered the PoP.

In an embodiment, in addition to break-even points, upper and lower bounds for the range of prices to be considered in the probability of profit analysis may be selected (i.e., such that prices down to zero or extending infinitely positive do not necessarily need to be considered when calculating a probability of profit). For the range lower bound of the range of prices to be considered in the probability of profit calculation, the difference between the maximum strike price and the minimum strike price (that is, the strike width) of the order may be subtracted from the current price of the security (i.e., the lower bound may be equal to the current price less the strike width), in an embodiment. If the lower bound is less than zero, it may be constrained to zero. In an embodiment, the upper bound may be equal to the sum of the current price and the strike width. Accordingly, in an embodiment, the range of prices to be considered for a profitability of profit calculation may be double the strike width, centered on the current price of the security. In other embodiments, other methods for determining an upper bound and/or a lower bound may be used.

The above-noted methodology of setting upper and lower bounds for the range of prices to consider in a probability of profit calculation may adequately balance maximizing accuracy and minimizing calculation burden, thereby enabling the trading system to quickly provide probability of profit calculations for a large number of trades, portfolios, etc. to a large number of users quickly.

As noted above, a P/L formula may be used to determine the roots of an order, in an embodiment. Numerous methods may be used to arrive at such a formula, in various embodiments. For example, in an exemplary embodiment, an intrinsic value method may be used. In another exemplary embodiment, a Black-Scholes formula may be used. A Black-Scholes formula may be preferred for orders having an expiration two months or more from the current date (i.e., the date of application of the formula) because a Black-Scholes formula may account for the number days to expiration and Implied Volatility (IV), whereas an intrinsic value method may not.

In an embodiment, for one or more P/L formulas, including an intrinsic value formula or a Black-Scholes formula, a method that may be followed for determining a P/L value for an order is: (a) given an underlying security price P, determine the theoretical or intrinsic P/L value for each element (leg) in an order; (b) sum the P/L values of the elements (legs); and (c) if buying the overall order or spread, subtract the cost of the order from the sum arrived at in (b) to arrive at the order's total P/L.

As stated above, an intrinsic value formula may be used to determine P/L. In an embodiment, the intrinsic value of an element or leg may be its current market value of at a given security price. Thus, intrinsic value is related to a selected price of a security, so that different potential prices of the security may be associated with different intrinsic values.

In an exemplary situation demonstrating calculation of an intrinsic value, consider an order with one leg that is a normal short put with a strike price at 15, the current stock price at 10, and the order price at 0.10 credit. Applying the order's price: 0.10*100 (option contract multiplier) brings the order's extrinsic value to 10.00 at strike price of 10. On the other hand, for a current price at 20, the price is above the strike price (and thus not in the money for a short put) so the intrinsic value at price 20 is zero.

As an alternative to an intrinsic value formula or method, a Black-Scholes formula may be applied to determine P/L. The Black-Scholes formula may be applied to each leg of the order separately, in an embodiment. The Black-Scholes equation is known in the art as an equation (or formula derived from the equation) for projecting the future price of an option, but is described briefly below.

A Black-Scholes formula for determining the price of any option over time may be derived from the Black-Scholes equation, shown as equation (1) below:

$$\frac{\partial V}{\partial t} + \frac{1}{2} {σ}^{2} {S}^{2} \frac{{\partial }^{2} V}{\partial {S}^{2}} + rS \frac{\partial V}{\partial S} - rV = 0 \qquad ( 1 )$$

where S is the price of the stock, t is time, Vis the price of the option as a function of S and t, σ is the standard deviation of the stock's return, and r is the risk free rate.

In an open-form analysis, finding roots may be performed according to one or more of several methodologies. For example, an iterative method may be used to find a rough range of a root and then Brent's method may be applied to find the exact value. This sequence of methods may be applied, in an embodiment, because the slope of the P/L curve can be zero at some points, which complicates Brent's method. As such, iteration may be performed to “step over” these flat areas of zero slope, and Brent's method may then be applied to find the exact root.

As noted above, open-form determination of roots may begin with a iterative process. In an iterative process, the approximate root points are found in the P/L function. The iterative process may include a plurality of “steps” across the function, with the values of the function at the ends of each “step” compared with each other (e.g., the signs of the values may be compared with each other, in an embodiment). In an embodiment, a number of steps may be selected that is equal to the price range width used for P/L calculation and divided by a selected error tolerance (which error tolerance may be 0.01, in an embodiment). The number of steps may be capped at a given number to reduce computation burden, in an embodiment. For example, the number of steps may be capped at an upper limit of 1000. The steps may cover the entire price range used for P/L calculation, in an embodiment. Each step may be of equal size, in an embodiment. Accordingly, each step may have a width equal to the width divided by the number of steps. During the iterative process, when the value's sign changes the process takes the previous step value and the current step value as the bounds for Brent's method to determine the exact root. Brent's method is well known in the art and thus will not be further described.

As noted above, once roots are found, the probability function can be integrated so that the area “under the curve” may be found for both profitable zones and non-profitable zones. The ratio of profitable area to non-profitable area may be calculated, which ratio may be considered the probability of profit.

Portfolio Probability of Profit. Portfolio Probability of Profit (PoP) may be found according to a method similar to that used for open form order PoP calculations, where each position in the portfolio is treated like a leg in an order. The different aspects may include, for example: stock positions may be ignored because they skew the results towards profit and loss which would be realized if the position were to be closed immediately, and P/L for an individual position may be beta-weighted to an index (such as, for example only, the SPDR S&P 500 ETF index, abbreviated SPY) to collapse a set of heterogeneous positions (different underlying symbols) into a single P/L, which can then provide a single overall P/L result.

In determining the PoP for a portfolio, the Black-Scholes method may be used for determination of roots (see Equation (1) above and the associated discussion). In applying the Black-Scholes method to a portfolio, the position in the portfolio with an expiration closest in time to the current time (i.e., the time at which the Black-Scholes method is applied) is used as the basis for the days to expiration value (time) and to determine the implied volatility value.

Another difference between determining PoP for a portfolio and open form PoP calculations for an order, as described above, is that portfolio PoP determination may include beta weighting. For example, in an embodiment, if the portfolio being evaluated only holds positions in a single underlying stock, no beta weighting may be applied; but for a portfolio with positions for multiple underlying stocks, a beta weight may be applied. In an embodiment, an index such as SPY may be used as the basis for beta weighting. The spot price for the index used for beta weighting may also serve as the spot price for the Black-Scholes formula, in an embodiment.

Further, to find roots for a portfolio PoP, in an embodiment, an iterative method may first be applied to the P/L function substantially as described above, then a bisection method may be used to find the exact root. Like Brent's method, bisection is a technique well known in the art and thus will not be described in further detail here.

Finally, as in an order PoP analysis, a portfolio PoP analysis may conclude with integrating the probability distribution function to determine the area “under the curve” for each zone, then determining the ratio of profitable “area” to non-profitable “area.”

In addition to a probability of profit for a position, multiple positions, a portfolio, etc., other useful statistics may be calculated and graphically shown to a user. These may include account performance and frequency by type of trade, sector, underlying stock, frequency or timing of trade entry or exit. The simplification of users historical trading activity into simple, easy to understand metrics provides them with 20-20 hindsight view of their trading activity, and also allows users to identify and determine profitable and unprofitable behavior, to improve their own investing performance. Capturing user data and tagging with appropriate structure on trade execution, to create a structured data system, will allow for simplistic and easy charts, graphs, and other visuals to be created from a user's trading activity. This activity can then be filtered and sorted by date, type, or other previously mentioned variables to create data sets for users to examine and learn from their previous trading behavior,

FIG. 10 depicts an example of an interactive feature 76 of a user's portfolio page 62, showing further information about an individual's option position listed in the portfolio page. The user's portfolio page 62 may also include interactive features to display further information related to the option position. For example, the interactive feature may further display additional numerical information about the position's loss, gain, current market value and daily gain.

Other interactive features of the portfolio page 62 can include a side bar quote, chart and current investment entertainment. Further, the portfolio page may provide access to tools to close or roll a position to a future expiration date, for example and/or to additional details about an individual's stock position. Such stock position details can include related options and overall stock performance information.

The portfolio page 62 may further include, in an embodiment, an indication of progress towards a profit level. The profit level may be a projected maximum profit, in an embodiment, or an actual maximum profit, in an embodiment (i.e., where the actual profit is bounded by the relationship between multiple elements of an order, multiple positions held with respect to the same underlying stock, etc.). For example, the portfolio page 62 may include a respective status bar 77 for one or more underlying stock symbols in the portfolio. For visual clarity, not all such status bars 77 are indicated in FIG. 10. The indication of progress towards maximum profitability may indicate probability on a percentage basis, in an embodiment. In the embodiment illustrated in FIG. 10, the status bars 77 indicate progress on a percentage basis, with a full status bar indicating 100%, and an empty status bar indicating 0%.

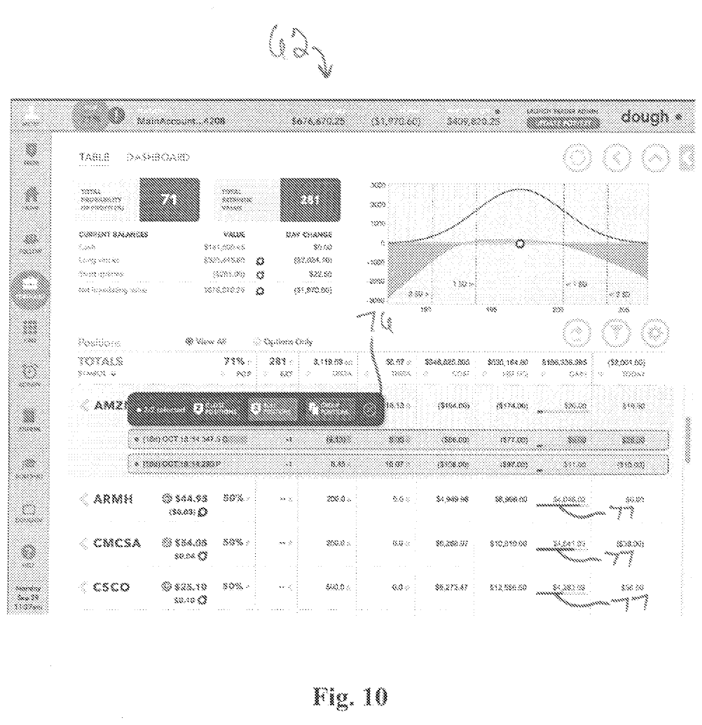

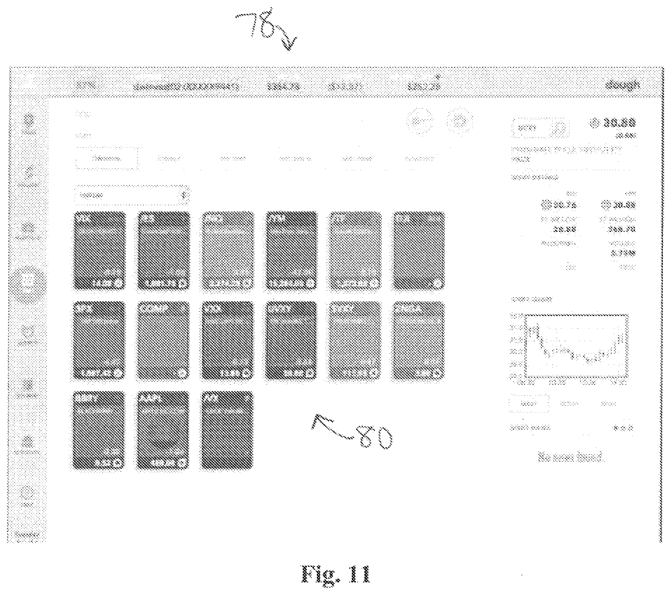

FIG. 11 depicts an embodiment of a page 78 for watching and analyzing relevant stock positions (i.e., a “ticker” page 78). A collection 80 of stock positions provided on the ticker page 78 can be selected by users of the platform or automatically selected by the platform. The ticker page 78 may provide a convenient way for users to watch and analyze their stock positions and/or other stock positions throughout the day. Data displayed can include the stock symbol, the most recent price, the net change for the day and a percentile display, in an embodiment. The percentile display can be indicative of the relationship between the current price and the 52-week high and low price or between the implied volatility and the 52-week historical implied volatility, in an embodiment.

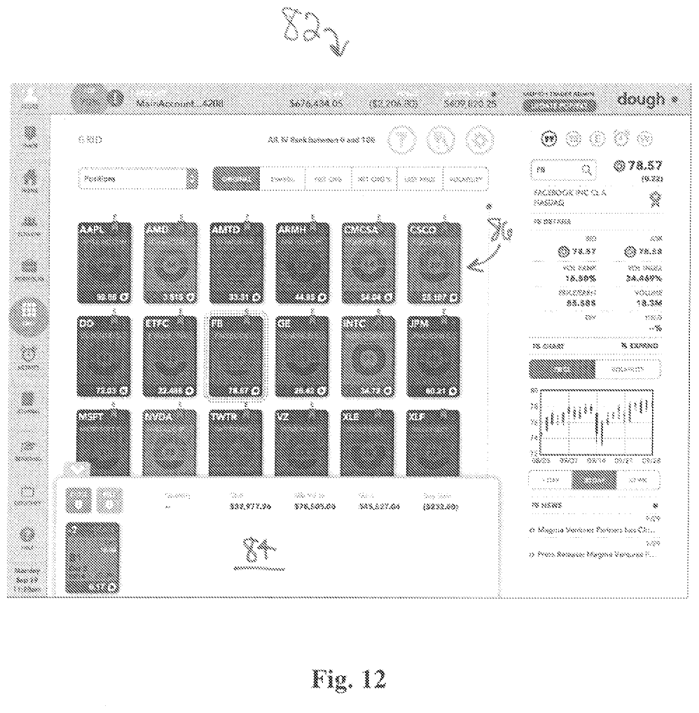

FIG. 12 depicts an example of a position detail feature page 82 that can be accessed from the ticker page 78, for example. The position detail feature page 82 may include related position details 84 or any related option positions 86. The related position details can include quantity, cost, market value, gain and day gain. The feature can further be used to display additional details about related option positions and will allow a user to close or roll those positions.

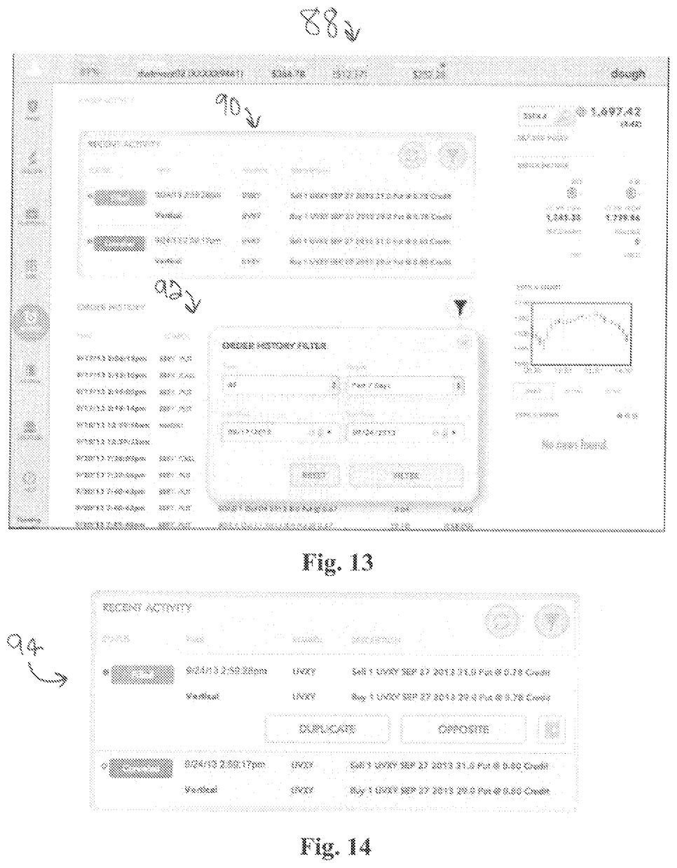

FIG. 13 depicts an embodiment of an account history page 88 for an investment, educational and entertainment website. The account history page 88 can be separated into a first portion 90 including activity from the current day or other time period and a second portion 92 including activity from the preceding days or another time period, in an embodiment.

From the account history page 88, a user can cancel, replace, duplicate and recreate existing orders, in an embodiment. FIG. 14 depicts one exemplary order duplication or opposition interface 94.

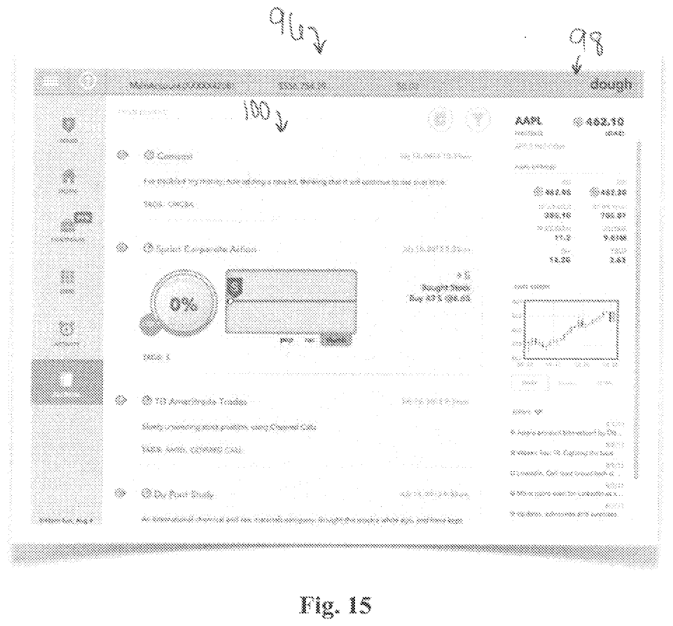

FIG. 15 depicts an embodiment of a journal page 96 for an investment, education and entertainment application. A user can use the journal page 96 to create and store notes and comments on the user's thoughts and reflections relating to investing and/or the application, in an embodiment. In addition, a user may store snapshots and information gained from the educational portions of the application. For example, a user may store snapshots and recipes he or she found insightful from the exemplary real traders displayed, in one embodiment, on the welcome page. Finally, a user may also store relevant investment news gathered from the application or from third parties.

The journal page 96 may also include a portion 98 that displays one or more of a user's stock and option orders, in an embodiment. This can allow for the user to track and comment upon specific orders. Journal entries can be tagged to the specific order, real trader, investment topic or in some other meaningful way.

The journal page may also provide access to collected data 100 respective of a user's entry conditions to better understand the user's own trading. For example, the journal page 96 may display, from the time a user's trade was placed, information like IV percentile, position relative to 52 week range, current implied volatility, underlying price, probability of profit, general market conditions, or days until upcoming events. The display of entry conditions may allow users to do retrospective analysis on profitable and nonprofitable trades to help them better understand profitable and unprofitable behavior. Also, capturing of entry conditions for display by the platform can help the platform identify user behavior patterns and recommend trades that the user may find interesting or appealing as determined by the platform.

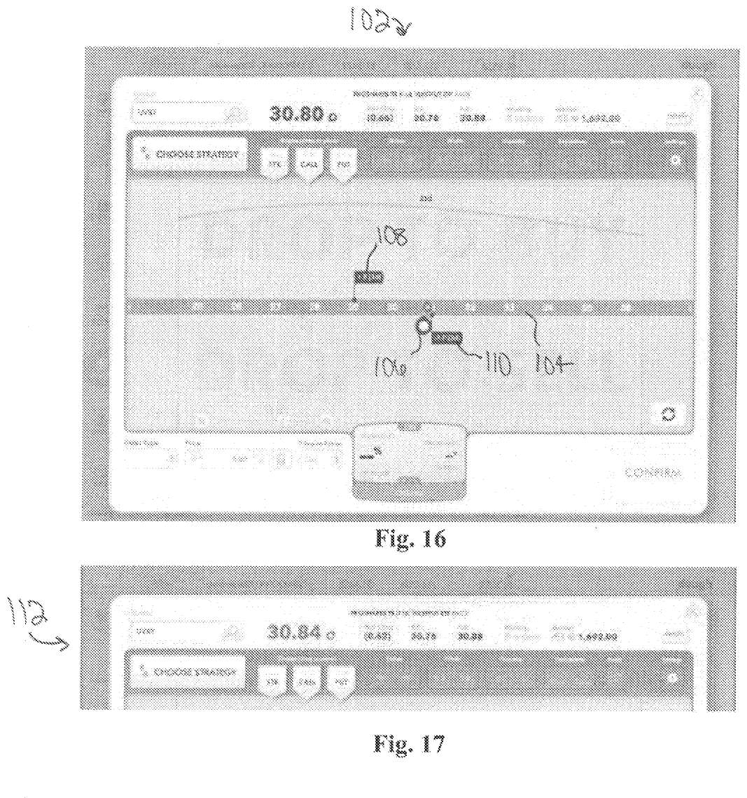

FIG. 16 depicts an order entry page 102 for an investment, educational and entertainment website. By processing investment data (e.g., stored in the trade data database, see FIG. 1), the platform may provide a diagrammatic and spatial display for the user to enter and tweak order parameters and to make the order.

Investment data that may be provided to the user to make a trade may include options price data and implied volatility, for example, as well as a probability of profit for a given set of parameters, as described in detail above.

The spatial description of risk allows users to quickly come to an evaluation of risk versus reward without needing to calculate specific numeric values. In one embodiment, multiple overlays relating to the outcomes can be overlaid on the Order Entry interface and delineate where the trade will profit, and what the mechanical and transactional side effects of each outcome will be.

The use of a diagrammatic and spatial interface as described herein can also be employed to create and display results of hypothetical simulations, where the user is allowed to initialize a simulation with the current market conditions, and run multiple random simulations, and view a plot of possible outcomes.

The use of the diagrammatic views and displays can also be shared between people, in order to communicate the structure, placement and risk associated with a trade. Investment data retrieved from the database can be used to indicate proper entry into a stock or option position, based on calculations of various metrics and their assumed reversion to each metric's mean value. Positions managed by the system can be marked as “appropriate to close” based on a combination of the acquired potential profit and investment data retrieved from the database.

In one embodiment the visual display of the option statistics can be based around a stock price range 104, as depicted in FIG. 16. The order entry page can show the last price 106. A user may be able to enter order parameters with respect to the stock price range 104; in an embodiment, placing an order leg indicator 108 above the stock price range may indicate an option to buy that leg and placing an order leg indicator 110 below the stock price line 104 may indicate an option to sell that leg. A user can enter the orders individually or through preset default orders. The order legs can be manipulated after a user has placed them by dragging the legs or editing the order through an edit feature that may be provided.

Preset default orders can be accessed through an order entry tools menu. One example of an order entry tools menu 112 is depicted in FIG. 17. This menu 112 can contain various tools for assisting a user in making and understanding a trade on the order entry page for an investment, educational, and entertainment application. The tools can include a details feature, a default order selection feature, a strike control, width control, quantity control, expirations control, swap feature and settings feature.

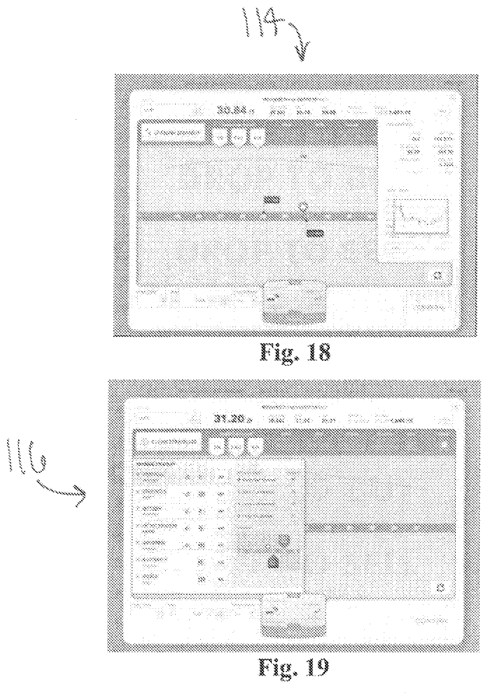

FIG. 18 depicts one example of a details feature 114 of an order entry tools menu for an order entry page. The feature can display a detailed quote panel, which may include additional quote information on the underlying position and it may include a simple chart on the underlying position.

FIG. 19 depicts one example of a default order selection feature 116 of an order entry tools menu for an order entry page. In one embodiment, this feature may include a “quick plays” portion that provides users with a set of pre-defined strategies (i.e., “quick plays”). Referring to FIGS. 1 and 19, the system 10 can provide users the order selection feature through the GUI. Further, the system 10 can be configured to display educational content related to the specific trade type directly through this feature. This educational content may be processed from the database 16.

In addition to providing users easy to access “quick plays”, users may also be provided with an “in-and-out” system, helping them to better identify when a trade should be made or how to get into a trade and when to get out of a trade. This system has two main components. The first is the good trade identifier. This system examines historical data of a stock implied volatility, volatility percentile relative to historical volatility, and other factors, to identify stocks that are approaching favorable conditions for a trade entry. At this point in time, a monitoring system will alert or suggest these stocks to the user as trades that may be potentially profitable. The next major feature of this trade is the trade monitoring and exit suggestion. Again, after a user has entered a trade, this system will begin to start checking the potential remaining profit left in a trade, against historically profitable exit thresholds for a given stock, and alert a user when one of their trades is beginning to approach the ideal exit threshold. At this point the user can quickly close out of their position, realizing their profit from the trade. In this way, the system or in-and-out, will allow users to more simply identify which stocks have favorable entry conditions and which existing trades possess favorable exit conditions.

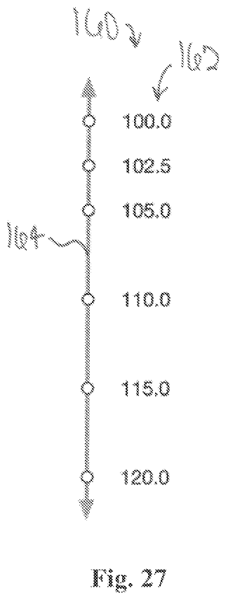

In an embodiment, a strike width for an order may be displayed on a linear scale. Additionally or alternatively, the strike width may be displayed on a logarithmic or other scale, providing the user with a different way to visualize different strikes, if desired. For example, as shown in FIG. 27, a strike selection menu 160 may be provided and may include a set of possible strike prices 162 that are displayed with reference to a linear scale 164 so that the trader can quickly and easily, through the trader's visual perception, understand and appreciate the relative numerical gaps between different strike prices. In contrast, known systems may provide strike prices in a simple table, which does not visually indicate the numerical distances between strike prices.

Strike widths, price ranges, and other metrics and numerical visualizations may also be provided in zoom-able display portions, in an embodiment. That is, the GUI may enable the user to zoom in our out to view a metric on a larger or smaller scale.

In addition to quick plays and manual order setting alterations by the user, the system may also enable single-click alterations of numerous aspects of an order. Such single-click alterations may be referred to herein as easy mutations.

FIG. 21 depicts an exemplary embodiment of a quick mutation interface 118. The interface 118 may include options 120 for selecting different strategies, as well as options 122 for altering several aspects of a selected trade strategy with a single click (i.e., quick mutations). In the exemplary embodiment of FIG. 21 (which depicts a sell put spread), the interface 118 includes quick mutation options for a lower strike, higher strike, narrower width, wider width, closer time, further time, and swap direction. These quick mutations are described in greater detail below.

FIG. 21 also illustrates a user's selected order parameters displayed on a price continuum 124 respective of the underlying stock. As noted above, in the embodiment of FIG. 21, a sell put spread is shown. The illustrated embodiment of the strategy includes a buy put 126 with a strike price of 80 and a date of April 21 and a sell put 128 with a strike price of 90 and a date of May 21.

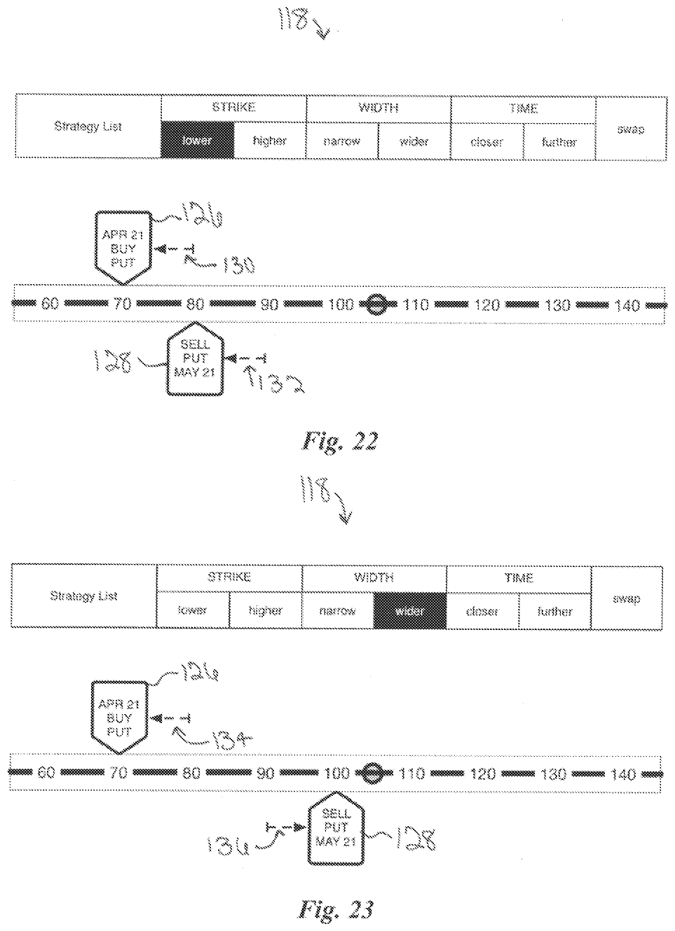

FIG. 22 depicts an exemplary embodiment of the operation of a “lower strike” quick mutation through the interface 118 of FIG. 21. As illustrated by the arrows 130, 132 associated with the buy put and sell put parameters, the lower strike quick mutation lowers the strike price of each element 126, 128 of the strategy. Thus, the buy put 126 strike price is lowered to 70, and the sell put 128 price is lowered to 80. The higher strike quick mutation may function in a similar fashion, increasing the strike price of each element 126, 128 of the strategy. In an embodiment, a lower strike or higher strike quick mutation may lower or raise all elements of a strategy by the same increment. Alternatively, a lower strike or higher strike quick mutation may lower or raise different elements of a strategy by different increments. Such increments may be selected by the user, in an embodiment.

FIG. 23 depicts an exemplary embodiment of the operation of a “wider strike” quick mutation through the interface 118 of FIG. 21. As illustrated by the arrows 134, 136 associated with the buy put and sell put parameters, the wider strike quick mutation increases the range between the elements of the strategy. Thus, the buy put strike price is lowered to 70, and the sell put price is increased to 100. The narrower strike quick mutation may function in a similar fashion, reducing the range between the elements of the strategy. In an embodiment, a wider strike or narrower strike quick mutation may shift all elements of a strategy by the same increment. Alternatively, a wider strike or narrower strike quick mutation may shift different elements of a strategy by different increments. Such increments may be selected by the user, in an embodiment.

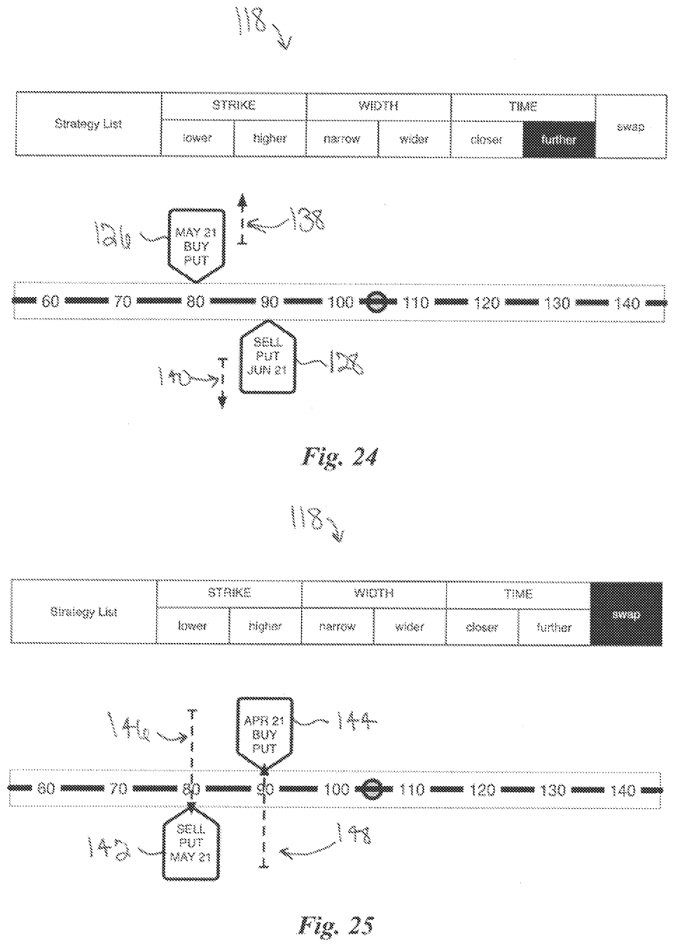

FIG. 24 depicts an exemplary embodiment of the operation of a “further time” quick mutation through the interface 118 of FIG. 21. As illustrated by the arrows 138, 140 associated with the buy put 126 and sell put 128 parameters, the further time quick mutation increases the time to expiration for each of the elements of the strategy. Thus, the buy put strike price expiration is increased to May 21, and the sell put expiration is increased to June 21. The closer time quick mutation may function in a similar fashion, reducing the time to expiration for each element of the strategy. In an embodiment, a further time or closer time quick mutation may shift all elements of a strategy by the same time increment. Alternatively, a further time or closer time quick mutation may shift different elements of a strategy by different time increments. Such increments may be selected by the user, in an embodiment.

FIG. 25 depicts an exemplary embodiment of the operation of a “swap direction” quick mutation through the interface 118 of FIG. 21. The swap direction quick mutation may swap the parameters of one element for the parameters of another element. For example, as illustrated by the arrows 146, 148 in FIG. 25, in the case of a sell put vertical strategy, the parameters (e.g., strike price and expiration date) of the buy put may be swapped with the parameters of the sell put to result in a sell put 142 and a buy put 144.

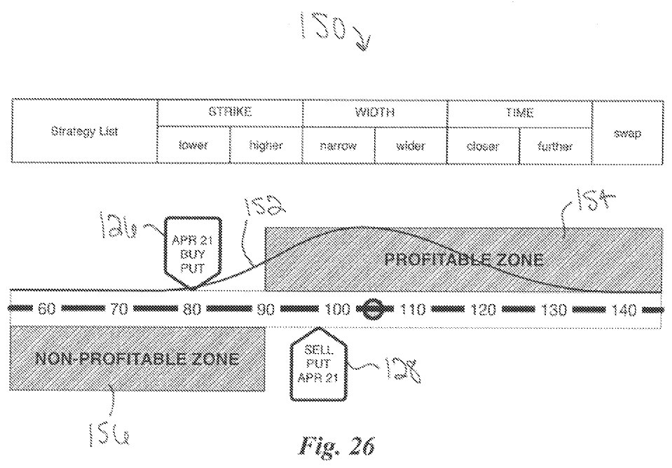

FIG. 26 depicts as exemplary overlay 150 of a stock price probability distribution 152, profitability zones, and parameters of an order, illustrating the concepts discussed with respect to FIGS. 19-25. In an embodiment, a single display of the GUI provided to the user may include indicators for elements 126, 128 of a selected order or strategy, a price probability distribution function 152 respective of a stock underlying the selected order or strategy, and profitability zones 154, 156 indicating which stock prices on the distribution would result in profit (zone 154), and which in loss (zone 156), for the selected parameters of the selected order. Accordingly, a user may be able to shift parameters of the order and view updated profit and loss zones provided by the system.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment,” or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

Although a number of embodiments have been described above with a certain degree of particularity, those skilled in the art could make numerous alterations to the disclosed embodiments without departing from the spirit or scope of this disclosure. For example, all joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. It is intended that all matter contained in the above description or shown in the accompanying drawings shall be interpreted as illustrative only and not limiting. Changes in detail or structure may be made without departing from the spirit of the disclosure as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A method of presenting investment data, comprising:
determining, for a selected continuous range of a plurality of possible future prices for a stock, a first set of prices within the range that will result in a profit for an option strategy respective of the stock and a second set of prices within the range that will result in a loss for the option strategy;
providing, for a user, a visual display having an indication of the first set of prices and the second set of prices overlaid on the selected continuous range.

2. The method of claim 1, further comprising:
calculating a first probability that a price of the stock at a specified future date will be equal to a price from the first set of prices;
calculating a second probability that the price of the stock at the specified future date will be equal to a price from the second set of prices; and
providing, within the visual display, a ratio of the first probability to the second probability as a probability that the option strategy will be profitable.

3. The method of claim 2, wherein calculating the first probability comprises integrating a probability distribution function respective of a range of all possible future prices of the stock across the first set of prices.

4. The method of claim 3, wherein calculating the second probability comprises integrating the probability distribution function respective of the range of all possible future prices of the stock across the second set of prices.

5. The method of claim 3, wherein the probability distribution function is a log-normal distribution.

6. The method of claim 5, wherein a standard deviation of the log-normal distribution is determined according to an implied volatility of the stock.

7. The method of claim 2, further comprising:
calculating a probability that a portfolio of option strategies including the option strategy will be profitable; and
providing, in the visual display, the probability that the portfolio will be profitable.

8. The method of claim 1, wherein a border between the first set and the second set is determined according to a closed-form calculation.

9. The method of claim 1, wherein a border between the first set and the second set is determined according to an open-form calculation comprising.

10. A method of facilitating an order for a securities purchase, comprising:
receiving a plurality of initial parameters of an option strategy respective of a stock from a user;
displaying, for the user, the plurality of initial parameters in a graphical interface;
receiving a single additional input from the user through the graphical interface;
altering two or more of the plurality of initial parameters according to the single additional input to create altered parameters; and
displaying, for the user, the altered parameters in the graphical interface.

11. The method of claim 10, wherein the single additional input is an indication to alter a strike price width, further wherein altering two or more of the initial parameters comprises increasing a strike price associated with a first element of the option strategy and decreasing a strike price associated with a second element of the option strategy.

12. The method of claim 10, wherein the single additional input is an indication to shift a strike price, further wherein altering two or more of the initial parameters comprises increasing respective strike prices associated with a first and a second element of the option strategy or decreasing respective strike prices associated with the first and second elements of the option strategy.

13. The method of claim 10, wherein the single additional input is an indication to shift an expiration date, further wherein altering two or more of the initial parameters comprises increasing respective expiration dates associated with a first and a second element of the option strategy or decreasing respective expiration dates associated with the first and second elements of the option strategy.

14. The method of claim 10, wherein the single additional input is an indication to swap a first element and a second element of the option strategy, further wherein altering two or more of the initial parameters comprises assigning, to the second element, a strike price and expiration date associated with the first element in the initial parameters and assigning, to the first element, a strike price and expiration date associated with the second element in the initial parameters.

15. The method of claim 10, further comprising providing a graphical menu of additional inputs from which the user may select the single additional input.

16. The method of claim 15, further comprising displaying the altered parameters with respect to a continuum of possible prices for the stock.

17. A system for investment, education and entertainment, the system comprising:
a database storing investment data and investment education data;
a processor in communication with the database, the processor configured to execute instructions to provide a graphical user interface (GUI) that displays selected portions of the investment data and selected portions of the investment education data;
wherein the GUI comprises:
an education portion that displays educational material selected by the user from the investment education data; and
an investment portion that accepts orders for securities trades from a user.

18. The system of claim 17, wherein the investment education data comprises videos including recommendations for trading stock options.

19. The system of claim 18, wherein the investment data comprises data respective of past securities trades by a plurality of users and data respective of past performance of stocks.

20. The system of claim 17, wherein the securities trades comprise stock option trades.
